(19) United States
(12) Patent Application Publication
(10) Pub. No.: US 2009/0055436 A1
(43) Pub. Date: Feb. 26, 2009

(54) System and Method for Integrating on Demand/Pull and Push Flow of Goods-and-Services Meta-Data, Including Coupon and Advertising, with Mobile and Wireless Applications

(76) Inventor: Olakunle Olaniyi Ayeni, Bolingbrook, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/019,979

(22) Filed: Jan. 25, 2008

Related U.S. Application Data
(60) Provisional application No. 60/956,869, filed on Aug. 20, 2007.

(51) Int. Cl. G06F 17/00

(52) U.S. Cl. 707/104.1; 707/E17.001

(57) ABSTRACT

The invention is a system and method, embodied in infrastructure platforms, that implements the suitable means of generating, storing, manipulating, distributing and utilizing marketing and sales oriented metadata that can be associated with goods and services offerings. It uniformly treats coupons, ads and similar marketing and sales information products as metadata about goods and services. It makes provisions for the goods and services metadata to be delivered via wireless technologies and devices. It allows consumers to trade or barter coupons and other metadata, according to individual needs, via an intermediary exchange or clearinghouse. It supports graded coupons and similar metadata, by allowing the redeemable value of such a coupon to be correlated with age. It supports the specialization, customization and personalization of the metadata and its redeemable value to be correlated with the roles, aspects and concerns of both producers and consumers of goods and services metadata.

### CROSS-REFERENCE TO RELATED APPLICATIONS

This patent application claims the benefit of U.S. Provisional Patent Application No. 60/956,869, filed Aug. 20, 2007, which is incorporated by reference.

### BACKGROUND OF THE INVENTION

The invention belongs to the area of generating, replenishing, distributing, storing, redeeming and using information products such as coupons and ads, to support and facilitate the marketing and sales of goods and services.

Coupons, ads and similar information types, which can be termed “goods and services metadata”, are typically used as vehicles by economic value chain participants for discounts, rebates, incentives, inducements and rewards for consumer behaviors in considering, evaluating, selecting, purchasing and using particular goods and services from particular manufacturers, vendors, suppliers, sales agents, value added resellers, distributors, dealers, brokers, wholesalers, retailers, malls, marketplaces, online stores and merchants.

Producers create or generate products and services (goods, items, things, stuff, commodities) that they attempt to market and sell to consumers. In marketing, advertising and sales, the primary and strategic objective of each producer is “to be noticed” by each consumer: to be seriously considered, to be in the running, to be evaluated, to be part of any comparisons, and ultimately to be selected or chosen as the source of a product or service.

Just like females at a lek of an animal species, consumers undergo behaviors and activities similar to those of mate selection: to search, seek, locate, tour, inspect, examine, evaluate, compare, contrast, decide, select, choose and optimize, with respect to goods and services.

Coupons, ads and similar metadata information products and messages are used by producers to get noticed (to be seriously considered and evaluated) and hopefully be selected by prospects, potential buyers, purchasers and users of goods and services, with the latter items being needed to meet human and institutional wants and needs. Thus, a coupon can serve as: enticement, inducement, nuptial gift, goodie bag, gift bag, reward, reinforcement, lure, bait, seducer, seduction, bribe, tribute, or offering, in order to modulate and influence pre-purchasing, co-purchasing and post-purchasing behaviors of consumers.

The operational decisions regarding metadata offerings and presentations to consumers require answering the following questions: a) When to? b) On what occasion? c) Where to? d) How to? e) What with? f) How much to? g) How many to? h) How long? i) How often? j) Whom to? k) Whom for? 1) Why to?

Even more significant is establishing answers to negative questions, that is, reasons for not doing certain activities pertaining to coupon offerings and presentations: a) Why not to? b) When not to? c) Where not to? d) Whom not to? e) How not to?

The inhibitions pertain to aspects, activities and metadata presentation and offering behaviors that are inappropriate, inaccurate, deceptive, fraudulent, irrelevant, intrusive, insulting, demeaning and shocking, overwhelming; or involve information junk, information flood, glut or deluge; or are situationally inconvenient; or involve complicated interaction protocols.

Conversely, goods and services metadata are more likely to be strategically effective, from the viewpoint of sales and marketing, if the availability and use is timely, accurate, authentic, correct, relevant, important, significant and worthwhile.

A major problem, which the invention addresses as a significant improvement on the existing state of the art, is the natural mismatch between how producers of coupons, ads and other metadata would like to deliver and present to consumers, versus what and how the consumers and users would like to interact with and use goods and services metadata.

In the hopes of reaching a lot of prospects and existing customers quickly, metadata producers would prefer to send metadata information products to as many customers and prospects as can be reached via all of the existing messaging delivery mechanisms and infrastructures. The producers would also prefer to take the initiative, to automatically send metadata information at anytime, to anyone located anywhere. This is termed the Push mode of delivery and presentation of metadata information products. Since, each producer is sending such metadata frequently, and several of them are doing so simultaneously, and at the same time the endpoint resources of a consumer are limited (including attention span, time, effort, etc.), if left unchecked the Push mode typically results in the annoying and dreaded phenomena of junk ads, junk mail, junk email and info-glut.

In contrast, potential consumers of the metadata information highly prefer access to and availability of goods and services metadata when it is relevant to a particular situation or endeavor; and more significantly, when they explicitly request such metadata information. Then each consumer will have a large a degree of control over the kind, amount and frequency of the metadata information that they actually confront and interact with. This is termed the On Demand or Pull mode of access, delivery and presentation of metadata information products.

The invention advances a solution which provides a correct and appropriate “impedance match” and adaptor-transformer between the Push side of metadata Producers and the Pull side of metadata Consumers, so that the preferences of both sides can be satisfied.

### BRIEF SUMMARY OF THE INVENTION

The invention is a system and method, embodied in infrastructure platforms, that implements the suitable means of generating, storing, manipulating, distributing and utilizing marketing and sales oriented (driven, related or based) metadata that can be associated with goods and services offerings.

The invention incorporates all of the following features:

Metadata, tag and annotation information and information products, (for example, coupons, ads, labels, marks), associated with goods and services, can be delivered to consumers and purchasers of the goods and services via mobile, wireless, cellular and portable technology, including but not limited to mobile phones and applications such as text messaging; email and voice; and mobile-enabled online, Internet-based Web sites.

Goods and services metadata in variety of forms, formats and embodiments are equally supported, either as specialized, hybrid or clustered/inter-associated cases, for example, coupons, ads, and coupon-ad hybrids.

Uniform support for and computational treatment as first order data types of goods and services metadata which play various pragmatic and purposive roles such as, discount, rebate, reward, incentive, gift card, points, tokens, deals, promotions, samples, updates, alerts, ads, coupons, announcements, notices, notes, labels, special offers, incentives, inducements, options, totems, logos, brands, brand names, icons, symbols, value cards, money cards, debit cards, savings, privileges, access, rights, authority, authorizations, license, tickets, tags, promise, credit, permission, and validation.

The metadata can be delivered via an intermediary's middleware-based adaptor driven infrastructure.

The intermediary infrastructure platform serves all of the following roles:

Memory and storage: It makes provisions for storing the goods and services metadata in electronic and digital depositories, which can also be variously called metadata bank, base, cache, buffer, queue or stack, (compare the terms database, data bank, data cache and data buffer, etc.)

Processing, operation, manipulation of the metadata in the depository: Software agents, bots, application servers can act as data filters to manipulate the goods and services metadata, for purposes such as sorting, ordering, query, aggregation, format conversion, as well as for targeted, specialized, customized and personalized query and searches.

Data transducers: Conversion of goods and services metadata from any formats in which they are generated by producers of the metadata, into formats more suitable for the consumers of the metadata in the depository; particularly, data formats that pertain to communication, exchange, distribution, delivery, access, and use by mobile and wireless based technologies and platforms, as well as end-user appliances and devices.

The distribution transmission and communication of the metadata that supports in a comprehensive manner all electronic and digital means, modes, media and channels that are portable, (anywhere and anytime access and use), and that are convenient for the consumers and users of the metadata.

Leverage the intermediate adaptor's role (the “middleware” portion) to add value that is of benefit, (economic, material, convenience, psychological, cognitive), for both the producers and consumers of the goods and services metadata.

Provide an intermediate adaptor mechanism that matches the information push tendency of the producers, with the pull preference of the consumers of the goods and services metadata.

Provide a convenient and automatic means to predict, identify, recognize, intercept and capture both the internal (mental) and the externally available purchasing behavior state transition signals of purchasers and consumers of goods and services. Then provide a mechanism that modulates, repackages and modifies the available signals, by inserting, enveloping, encapsulating, piggy-backing and transmitting goods and services metadata to the consumers, at the time, (and also beyond), the intercept and capture of the state transition behavior signals.

Provide several multiple means of delivery of graded or graduated metadata to consumers.

Provide an exchange and match-making infrastructure platform at the intermediary adaptor, so that consumers who receive metadata (such as coupons) offerings that they cannot use themselves immediately for purchasing and procurement transactions, can trade, barter or exchange these coupons and other metadata with other consumers who have presence on the intermediary.

### BRIEF DESCRIPTION OF THE SEVERAL VIEWS OF THE DRAWING(S)

FIG. 1: Depicts the three major subsystems of the invention's system and infrastructure platform. Namely, A) the collection of entities that create, generate or produce (101) the goods and services metadata, (for example, coupons and ads); B) the intermediary subsystem (102) that provides a depository and clearinghouse, as well as a means for distributing and disseminating the generated metadata; and C) the collection of entities that receive and utilize the metadata (103) in the purchase, consumption and use of goods and services.

FIG. 2: Depicts the invention's system and infrastructure platform in the bigger context of its support for goods and services economic value chains (201), involving goods and services production, distribution, marketing and sales, installation and operation, and use (203).

FIG. 3: Depicts a message sequence chart (or orchestration chart) of the transaction processes of the workflow of goods and services metadata generation and production, storage and manipulation, and utilization and consumption, through the invention's subsystems.

FIG. 4: Depicts the separation of the variety and multiplicity of roles (191), aspects and concerns of the goods and services metadata producers (101). It also depicts the separation of the variety and multiplicity of roles (193), aspects and concerns of the goods and services metadata consumers (103).

FIG. 5: Depicts the separation of the variety and multiplicity of roles, aspects and concerns of communication channels (501) and goods and services metadata messaging delivery vehicles and formats (500) that can be used in the invention to interface with the consumers and users of the metadata (103).

FIG. 6: Depicts the component of the invention that allows other (third party) intermediaries (202) in purchasing transactions, for example, credit card service providers, to be integrated with the goods and services metadata intermediary (102); so as to leverage the interception and capture of signals generated by consumer purchasing transaction behavior state transitions.

FIG. 7: Provides more details about the integration of the metadata intermediary (102) with other third party intermediaries (202) in purchasing transactions, as shown in FIG. 6.

FIG. 8: Depicts a message sequence chart (or orchestration chart) that describes the workflow processes involved in the integration of the goods and services metadata intermediary (102) with other third party intermediaries (202) involved in purchasing transactions, as shown in FIG. 6 and FIG. 7.

FIG. 9: Depicts the subsystems of the invention that support the Push/Pull transformers and adaptation (“impedance matching”) in the production and consumption of goods and services metadata.

FIG. 10: Provides more details about the invention's components to support the Push/Pull transformers and filtering, as shown in FIG. 9.

### DETAILED DESCRIPTION OF THE INVENTION

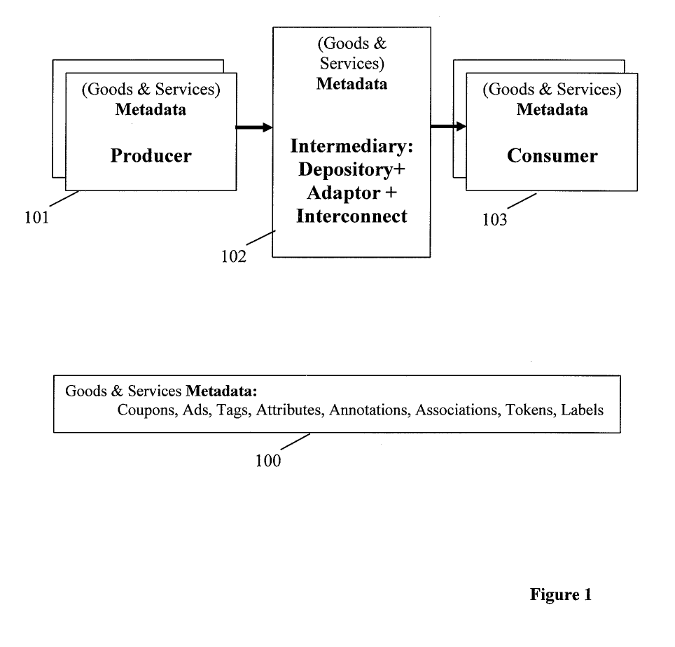

The major technological components of the infrastructure platform and system of the invention are as shown in FIG. 1. They comprise of A) a collection of entities, called goods and services metadata Producers (101) that create, generate, aggregate and package metadata information products (100) associated with goods and services; B) an Intermediary subsystem (102) that is a collection of metadata Depositories (metadata banks, bases, caches, buffers, queues, stacks, storage, memory, blackboards, clearinghouses), together with metadata manipulation Adaptor agents, bots and applications; and C) a collection of entities, called goods and services metadata Consumers (103), who can receive or obtain the metadata, (from the metadata Intermediary) and utilize the metadata in purchasing decisions, choices and transactions. The preferred embodiment of the interactions between the major subsystems of the invention is via major global networks and inter-networks, such as the Internet, Web services and the integrated collection of (global, national, regional and metropolitan) wireless, cellular and mobile telecommunications and data networks.

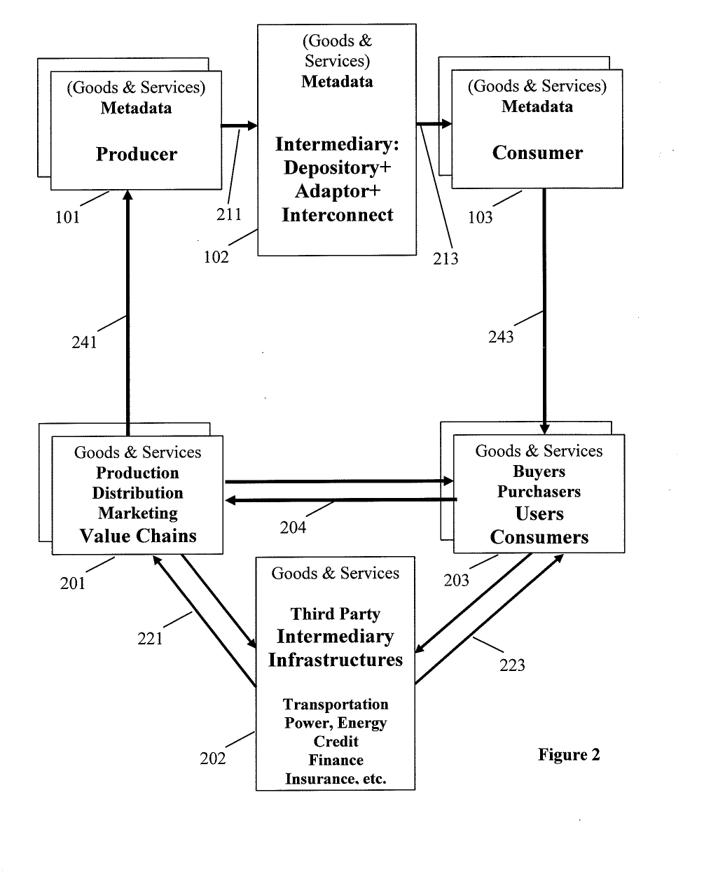

As shown in FIG. 2, any embodiment of the invention will occur in a larger context of values chains (201) that produce, distribute, market, sell and services goods and utilities to consumers (203), who act as buyers and purchasers of the goods and services. Metadata is generated to support (241) goods and services to be marketed and sold. In the invention's embodiment, these metadata flow (211) from the metadata Producers to the metadata Intermediary (102), where the metadata can be stored and manipulated as middleware knowledge, information, intelligence and data (Ki²D) (102).

For example, each metadata in the form of a coupon is automatically tagged with associated or annotated keywords, vendor brand name, retailer or vendor business name/logo, bar code (UPC, SKU, EPC), as well as with any other product identification information.

The metadata is eventually made available to metadata Consumers (103), in various representation and presentation formats, via flows from (213) the metadata Intermediary (102) to the metadata Consumers (103). The metadata Consumers (103) utilize (243) available metadata in purchasing, procurement and provisioning choices, decisions and transactions to acquire, operate, manage, use, repair, upgrade and maintain various goods and. services.

The invention also supports the integration of the metadata Intermediary (102) with the involvement of other, third party intermediaries, (such as credit service providers), in purchasing (buy/sell) transactions and interactions (204, 221, 223). Also included in this aspect of the invention is support for integration with third parties which are not participants in financial transactions; such as but not limited to, social networking Web sites, online communities and virtual communities; blogs, wikis, tikis; specialized search engines, such as for jobs and air travel, tourism, vacations, weddings, honeymoons; specialized Web destinations, portals and gateways, exchanges and marketplaces, such as for health, mortgages, nutrition, food, cooking, cuisines, aging, collectibles, micro-breweries, classifieds, dating, match-making, and romance novels; community information products, such as Wikipedia.org, open source software development Web sites; search engine tool bars; consumer-to-consumer (C2C) exchanges, and electronic, digital online marketplaces.

The invention also supports the integration of the metadata Intermediary (102) with infrastructures that support several other types and forms of cards and tags, including but not limited to debit cards, welfare cards, benefit cards, social service cards, health service cards, and military id cards.

Furthermore, the invention can support a hierarchy of metadata, such as a multi-layer sequence of information products (tickets, tags, etc.), called pre-coupons, that can eventually and ultimately be converted and redeemed as coupons.

The invention supports the redeeming of coupons at any point or stage in the purchasing life cycle, including: before, during or after specification, research, searching, locating, seeking, order, purchase request, purchase, payment, taking receipt of delivery, installation, operation, management, administration, usage, learning, training, instruction, education of usage, repair, maintenance, upgrade, migration and decommissioning.

A related aspect of the invention is the support of hybrid coupons+ads. An ad can have an associated “temporarily hidden” coupon (cryptic, chameleonic coupon) which “pops up” and becomes visible after an ad viewer (103) has spent a specific amount of time or effort (mouse clicks) on the ad. Similarly, a coupon may have associated with it a graded sequence of ads. The redeemable value of the coupon increases in a graduated way, as the metadata Consumer (103) views an increasing number of ads in the associated graduated sequence.

Another related aspect is the invention's support of co-coupons or coupon clusters, bundles or bags. In this case, coupons meant to be associated in a bundle increase greatly in value if a metadata Consumer (103) “collects” or aggregates the co-coupons, “collect them all coupons,” that are designed to be in the specific coupon cluster.

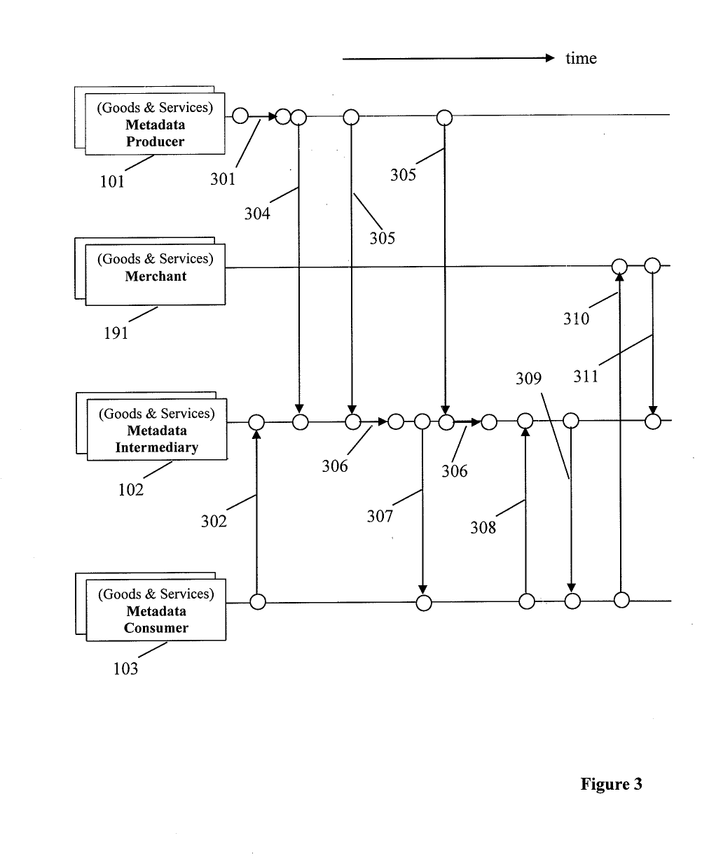

FIG. 3 shows details of transaction processes and workflows in the production, storage, manipulation and distribution, and utilization of goods and services metadata, as supported in the invention. Metadata Producers (101) generate (301) the metadata to be associated with specific goods and services.

The metadata producers can use any data representation formats that have been negotiated with (304), or are familiar to, the metadata the metadata Intermediary (102). The metadata (100) from the metadata Producers (101) can be transmitted to or communicated with the metadata Intermediary (102) via any established data and tele-communications media, channels or technologies (305). The metadata Intermediary (102) stores the received metadata in variety of metadata depositories, databases and databanks.

The stored metadata (100) can then be subjected to various operations and manipulations (306), including but not limited to filtering, sorting, ranking, tagging, repackaging, consolidation, re-clustering, encapsulation, segmentation, decomposition, mutation, modification, personalization, and customization.

The re-processed metadata is then made available to (309) the metadata Consumers (103); either on the initiative of the metadata Intermediary (102), called Push flow (307), or on the initiative of metadata Consumers (103), called On Demand or Pull flow (308). A metadata Consumer (103), as a purchaser of goods and services, may then use any number of metadata in its possession to participate in purchasing transactions (310, 31 1) with a goods and services Merchant or Service Provider (191).

The invention, by means of separation of concerns, aspects and roles (SOCAR), carefully distinguishes and supports, (via personalization, customization, specialization and situational adaptation), multiple roles, incarnations and embodiments (191) of metadata Producers (101). These value chain roles (191) of producing, distributing, marketing, selling, servicing goods and services include, but are not limited to: manufacturer, vendor, supplier, marketer, coupon/ad aggregator, advertiser, service provider, store, wholesaler, distributor, retailer and merchant.

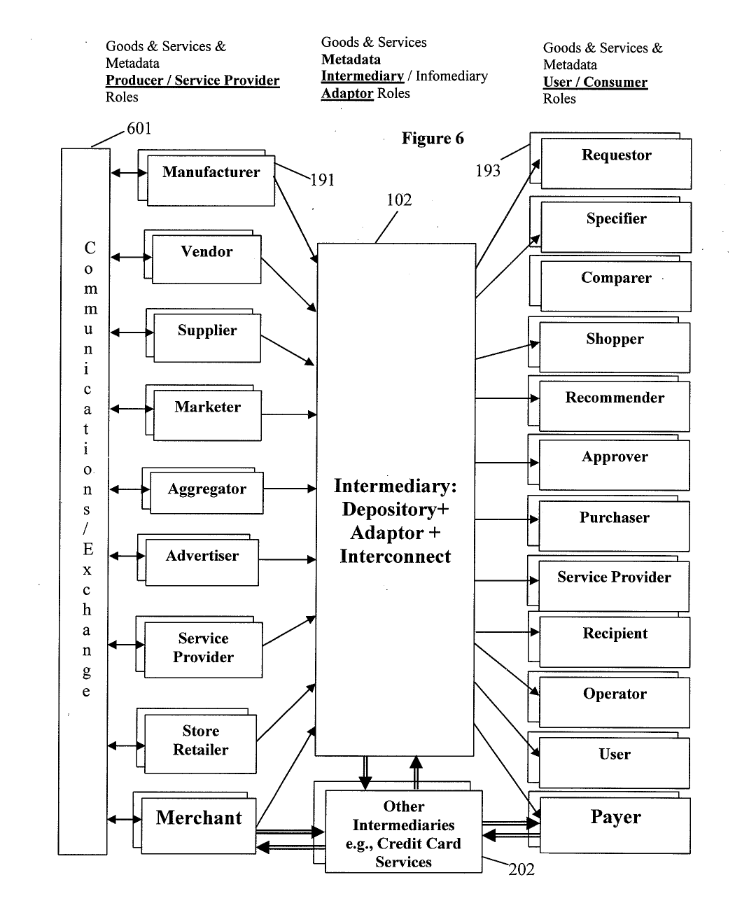

Also, as shown in FIG. 6, apart from the rendezvous resources available to them in the metadata Intermediary Depository(ies), the metadata Producers (101) also have additional back channel communications and exchange infrastructures (601), for cooperative and collaborative generation and re-packaging of goods and services metadata information products, before the latter products are transmitted to the metadata Intermediary (102).

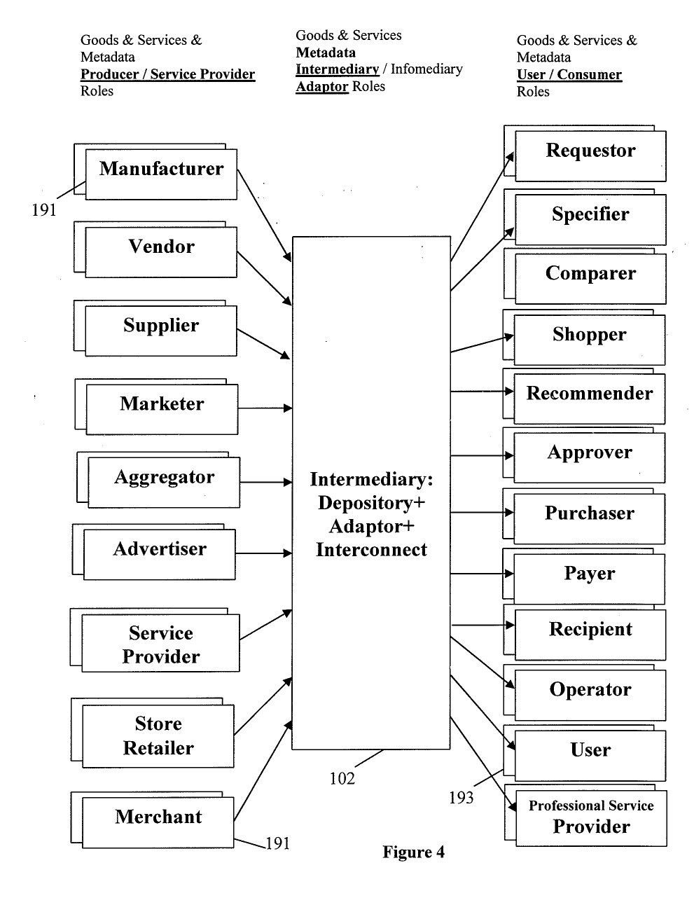

Similarly, the invention, by means of separation of concerns, aspects and roles (SOCAR), carefully distinguishes and supports, (via personalization, customization, specialization and situational adaptation), multiple roles, incarnations and embodiments (193) of metadata Consumers (101). These value chain roles (193) of procuring, provisioning, buying, installing, operating, managing, using, repairing, maintaining, upgrading, learning/training about goods and services include, but are not limited to: requestor of need or want, specifier or characterizer of need or want, comparer and evaluator of options and choices, shopper, researcher, browser, searcher, finder, locator, seeker, approver, recommender, purchaser, procurer, buyer, payer, goods recipient, beneficiary, operator, manager, administrator, user and professional service provider on behalf of a client, customer or patient. The invention's separation of these roles is shown in FIG. 4.

The invention is capable of attaching and utilizing metadata information products with several product life cycle support stages or phases user/consumer/customer behaviors and state transitions, including but not limited to product recalls, product returns, reverse logistics, trouble reporting, trouble shooting, feedback, comments and unsolicited recommendations and promotions (word-of-mouth), warranty and registration card returns.

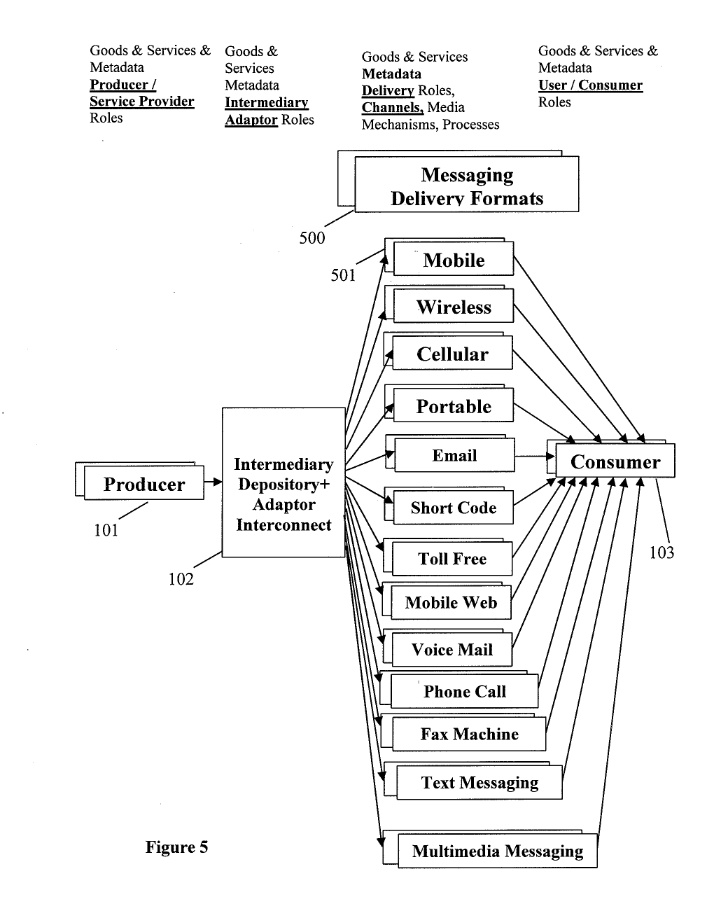

The embodiments of the invention seamlessly support multiple metadata messaging delivery formats for making goods and services metadata information from the metadata Intermediary (102) available to the metadata Consumers (103). As shown in FIG. 5, the communication technologies that can be used for the metadata messaging delivery component of the invention include but are not limited to mobile, wireless and cellular infrastructures, appliances, devices and handsets, including but not limited to mobile phones, cell phones, and smart phones.

Additional support incorporates portable consumer electronic devices as delivery medium, including but not limited to laptops, personal digital assistants (PDAs), notebook, tablet and e-book PCs, MP3 players, as well as media and multimedia players. As further refinement of the above delivery mechanisms, the invention supports multiple forms of human-computer interaction/user interface (HCI/UI) technologies. These include but are not limited to, short code, keyword value (attribute value) pairs, bar code, portable bar code, mobile barcode, RFID tag formats (EPC), fax, fax mail, phone calls, voice mail, electronic mail (email), wireless access protocol (WAP), instant messaging (IM), mobile Web sites, pages and documents, text messaging, such as SMS and multimedia messaging.

In the On Demand/Pull mode, the invention allows a metadata Consumer (103) to request or access and retrieve goods and services metadata (such as coupons) by means of search or query criteria including, but not limited to the several attributes, tags, labels, annotations associated as meta “dimensions” in the metadata Intermediary (102) Depositories, for example, including but not limited to keyword, brand name, merchant name, id or logo, bar code, and EPC code.

Furthermore, the delivery of metadata to a metadata Customer (103) can be specialized, customized and personalized, such as according to, but not limited to geographical location information, geo-coding, GPS or e-911 localization.

Furthermore, in a Pull/On Demand mode, the invention allows a metadata Consumer to use one communication and delivery mechanism or infrastructure to request the metadata (100) to be delivered; but the actual delivery of the metadata message or information product (100) occurs on a different separate communication, delivery mechanism, infrastructure or presentation format. This may be termed cross-modal delivery messaging, for example, including but not limited to voice-to-sms, voice-to-mms, voice-to-email, voice-to-wap, voice-to-IM, voice-to-bar code, as well as the converse inter-couplings.

Furthermore, the invention allows a metadata Consumer (103) to request a particular metadata message or information product to be re-directed (re-routed or forwarded, copied, blind carbon copied) and targeted at one or more other different metadata Consumers (103).

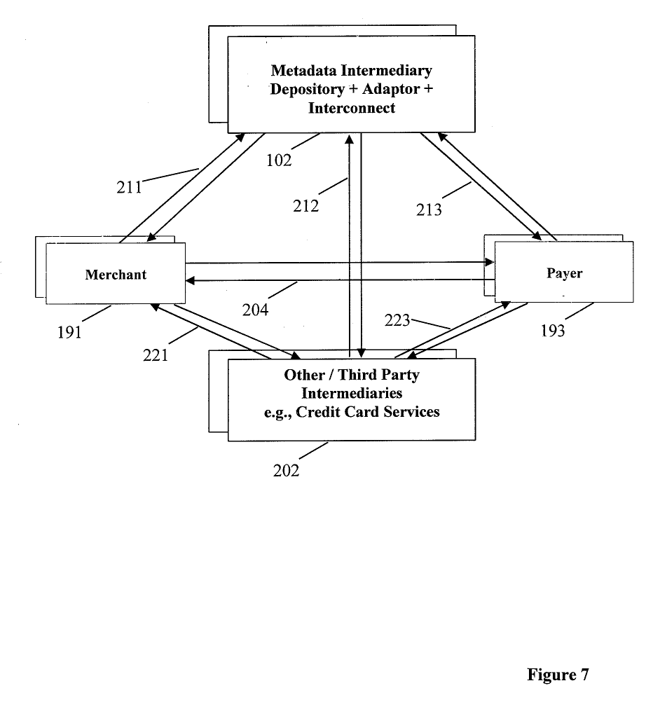

As depicted in FIG. 6 and FIG. 7, a significant part of the invention is the capability to integrate and involve the metadata Intermediary (102) in ongoing purchasing and payment transactions and interactions (204) between merchants (191) and buyers / payers (193). Then, other third party Intermediaries (202) involved in those transactions (221, 223) are able to intercept and capture purchasing behavior and state transition signals of goods and services users and consumers (203), and then forward such signals (212) to the metadata Intermediary (102). The metadata Intermediary (102) can then leverage the ongoing purchasing transaction, by piggy-backing on transactions' communication channels and modes (211, 213), for example, by immediate, concurrent or parallel presentation of a metadata information to the consumer before the purchasing transaction is consummated and terminated. Thus, such consumers' purchasing state transition signals can be manipulated via detection, characterization and recognition; interception and capture.

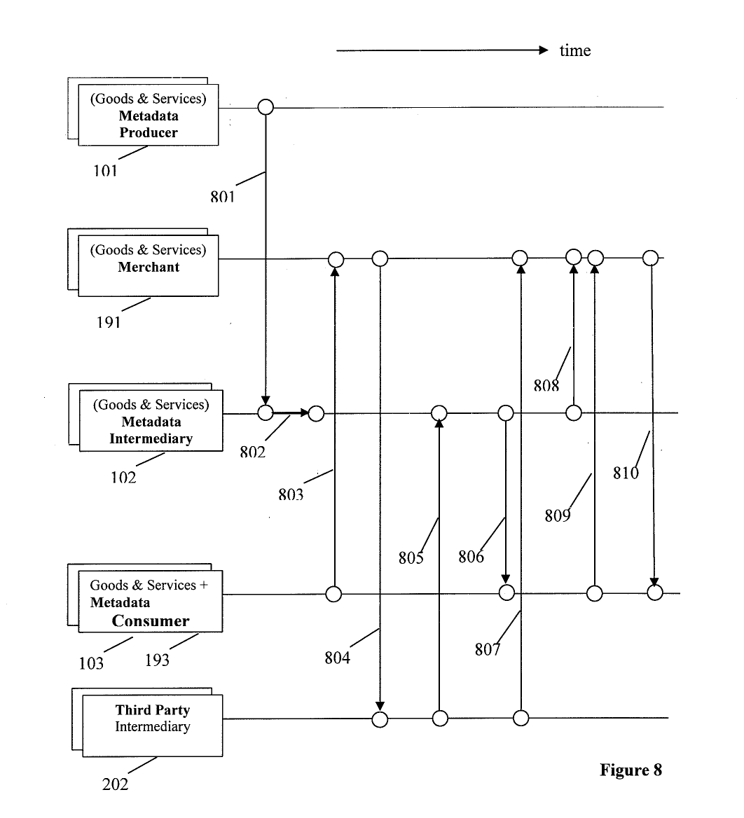

The details of the invention's support of such online, real-time integration with third party Intermediaries (202) are shown in FIG. 8. By prior arrangement, one or more metadata Producers (101) transmit (801) specific blocks of metadata information products to the metadata Intermediary (102), who re-processes (802) the metadata into forms suitable for metadata Consumers (103).

As a concrete example, in the role of a purchaser/payer of goods and services (193/103), a metadata Consumer (103) presents a credit card or debit card (803) to a point of sale (POS) of a Merchant (191). The Merchant (191) sends (804) the credit/debit card authentication, validation and authorization sales request and associated information via an established infrastructure to a third party Intermediary (202), (for example, bank/debit card processor, or credit card services provider). Assuming the sales request is validated (albeit, it may or may not be approved), in a process called nudging, the third party Intermediary (202) transmits (805) a purchasing transaction-in-progress signal or indication to the metadata Intermediary (102), while simultaneously sending (807) the status and resolution of the sales request back to the Merchant (191). The metadata Intermediary (102) then uses the information associated with the transaction-in-progress nudge signal to generate a customized, specialized, personalized or adapted metadata information product that is sent immediately (806) to the customer, who is about the complete the sales/purchase transaction at the Merchant's POS. Optionally, the metadata Intermediary (102) may also send (808) an associated metadata message or indication about the ongoing transaction to the Merchant (191). In the dual role of a metadata Consumer (103), at the customer's discretion and initiative, the customer can use the newly available metadata information product to complete the ongoing transaction (809, 810); defer the use for a future sales/purchase decision or transaction; or completely ignore it.

The invention resolves the extant incompatibility or mismatch between the Push tendencies of metadata Producers (101) and the Pull preferences of metadata Consumers (103) in the following manner. The overall metadata Depository of the metadata Intermediary (102) is partitioned into three separate independent components, (called metadata blackboards), that are only inter-linked via specialized software agents, filters and adaptors. These components are A) Push Depository (901); B) Pull Depository (903); and C) Inter-switch Blackboard (902).

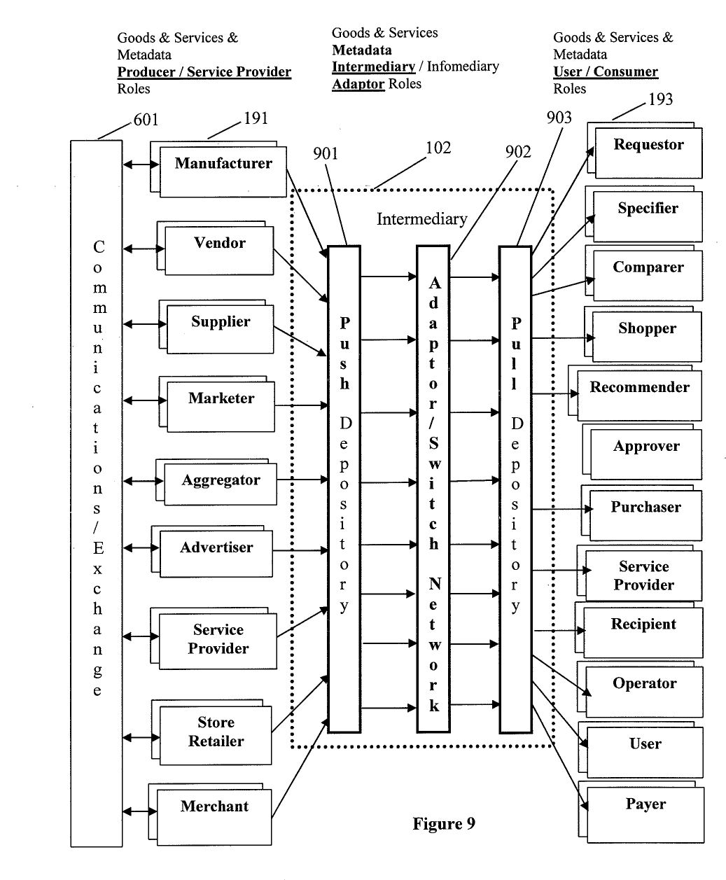

As shown in FIG. 9, the Push Depository (901) is made available for the exclusive use of the metadata Producers (101), in all their various roles. Similarly, the Pull Depository (903) is made available for the exclusive use of the metadata Consumers (103), in all their various roles.

Subject only to storage capacity limitations and constraints, metadata Producers (101) can create, generate and package goods and services metadata information for the general consumer population (broadcast, 1-to-all), targeted sub-populations of consumers (multi-cast, 1-to-many, 1-to-some), or targeted to specific individual consumers (unicast, 1-to-1). Whomever the targeted population, whatever the frequency, whatever the volume, amount or quantity, and whatever the complexity, all metadata Producer (101) generated metadata information products are destined for and end up in the Push Depository (901), and are intentionally kept from reaching the metadata Consumers (103) directly.

The invention provides software agents, bots and application servers that take metadata information in the Push Depository (901), re-process the data, and then place copies of the reprocessed metadata information products in the Inter-switch Blackboard (902). The major transformations of the metadata up to that point include, but are not limited to filtering, specialization, re-packaging, re-bundling, encapsulation, reformatting or format conversion, classification, abstract data typing, vector coding, multi-colored tagging, and semi-structuring into intelligent content by using hidden tag associations or annotations.

Additional specialized software agents, bots and application servers then manipulate, reprocess and refine copies of the metadata in the Inter-switch Blackboard (902) and place copies of the metadata refinements in the Pull Depository (903).

Each metadata Consumer (103), of which the metadata Intermediary (102) is aware, has allocated to it, a very small storage capacity, called MyCoupons (123) allocated from the Pull Depository (903). A MyCoupons (123) space can be likened to a personal voice, email, fax or postal mailbox. At any time, only the metadata information or messages in the associated MyCoupons (123) mailbox are directly available, accessible, or retrievable by an individual metadata Consumer (103). The MyCoupons (123) metadata reaches the metadata Consumer (103) because the metadata Consumer (103) requests all or some of the information, this access mode is termed Pull or On Demand access. Alternatively, according to prior arrangements and agreements, regarding amounts, kinds and frequencies, the appropriate software agents in the metadata Intermediary (102) may or can automatically deliver the MyCoupons (123) metadata information to the associated individual metadata Consumer (103). This alternative access mode is termed Trickle Push access; to contrast it with Flooding or info-glut Push access, whereby the information in the Push Depository (901), (or even that in the Inter-switch Blackboard (902)), were to be presented directly and frequently to individual metadata Consumers (103).

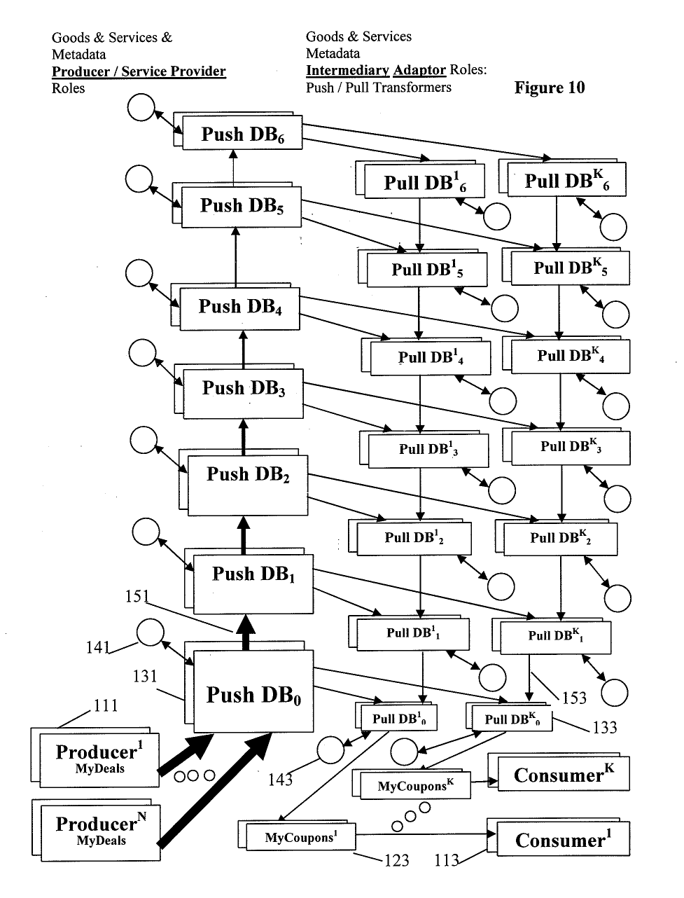

FIG. 10 shows further details of the implementation of the tripartite structure of the metadata Intermediary (102) Depository.

The Push Depository (901) is implemented as a multi-stage, multi-level storage or memory hierarchy, with the successive stages or levels, called Push DB (131), interlinked by (intelligent, smart, knowledge-based and specialized) software agents, multi-agent systems, bots and application servers (151). There are additional intra-level software agents, bots and application servers, for each level (141). The metadata Producers (101) dump their “raw” metadata information products in the lowest order Push DB, called Producers MyDeals Push DB (111); then the various software agent move reprocessed versions of the metadata Producers' (101) metadata (100) through successive Push DB (131) stages, until some refined form reaches the Pull Depository (903) structure, via the Inter-switch Blackboard (902).

As shown in the FIG. 10, the Pull Depository (903) is implemented as a collection of pipeline stages (multi-level storage hierarchies of buffers, caches, register files/banks, stacks, queues), with the stages called Pull DBs (133). Each Pull pipeline is associated with either an individual or with a small population of metadata Consumers (103). Again, the successive Pull DB stages (133) are interlinked by (intelligent, smart, knowledge-based and specialized) software agents, multi-agent systems, bots, and application servers (153). There are additional intra-level software agents, bots and application servers, for each level (143) in the Pull Depository (903).

Some of the intra-level software agents for Pull DBs (153) can use established algorithms, such as Hidden Markov Models (HMM) and Artificial Neural Networks (ANN), to forecast and predict consumer purchasing transaction behavior states and state transitions for individual or classes of metadata Consumers. This is particularly useful for those consumer state transitions that are not readily externally observable, due to the lack of associated signaling characteristics. Examples include states for needs and wants of goods and services; comparing, contrasting and ranking choices and alternatives of goods and services; as well as deciding on specific goods and services to patronize.

The final stage of each Pull pipeline interfaces with a MyCoupons (123) storage capacity. Each MyCoupons (123) space is finally terminated with a metadata Consumer specialized area (113). This specialized storage area (113) is the only directly accessible and available to requests from the associated metadata Consumer (103).

Thus, the flow of the metadata information through the metadata Intermediary (102) Depository infrastructure can be likened to flow of raw materials through a multi-stage, multi-pipelined refinery or manufacturing plant. It can also be likened to ingested food processing in the alimentary canal and digestive system.

The overall structure of the Depository, (with respect to any single metadata Consumer (103)), can also be likened to an iceberg: the input side of the Push Directory contains a huge amount information and data; while at the other end, the output side of the Pull Depository contains only a trickle of information that is directly available to each metadata Consumer. It may also be likened to reverse flow of water in a river system, anti-river; where the flow is from the sea towards the sources of the streams and rivulets in the catchments area that combine to form the final river that discharges into the sea (or lake).

The organization of the Intermediary (102) Depository can also be likened to the distinction between “conscious” memory (compare Pull Depository (901)) and “sub-conscious/unconscious” memory (compare Push Depository (903)).

The transformers between the various stages in the Push Depository (901) and Pull Depository (903) can be likened to (step-down) transformers used by power utilities and electric grids in the transmission and distribution of electric power and energy.

The invention also implements graded or graduated metadata. An example of such a graded metadata, such as graded coupons, is that the value of a graded coupon changes according to age or time of use. For example, when issued, the value of a graded coupon can be 100 A, if it is used (redeemed) immediately; otherwise, the value decreases to 0.5 A, if it is used within a week; otherwise, the value decreases to 0.25 A, if it is used within a month, and so on. Thus, graded coupons, and other similar goods and services metadata (100), can be termed coupons with “half-life”. Therefore, the invention supports coupons and other metadata which have unlimited expiration dates; although the redeemable value at any time can be implemented to be dependent on or correlated with the age of the metadata information product (100).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for integrating pull and push flow of goods and services metadata, the system comprising:
a plurality of goods and services metadata producers;
an intermediary adapter that receives metadata from metadata producers, matches the metadata to consumer preferences, and transmits the preferred metadata to one or more consumer devices;
a plurality of consumer devices that provides consumers preferences for metadata to and receives metadata from the intermediary adaptor;
a financial software application that receives a financial transaction and then transmits a transaction-in-progress signal to the intermediary adaptor to send metadata to the consumer based on the financial transaction; and
a plurality of delivery mechanisms that deliver metadata between metadata producers and the intermediary adaptor and between the intermediary adapter and one or more consumer devices.

2. A system according to claim 1, wherein the goods and services metadata producers create, generate, aggregate, package, and transmit metadata to an intermediary adapter.

3. A system according to claim 1, wherein the intermediary adapter comprises:
a plurality of metadata depositories that store metadata based on consumer preferences; and
manipulation software applications performing functions on the stored metadata in the metadata depositories.

4. A system according to claim 3, wherein the metadata depositories are at least one from the group consisting of metadata push depository, Inter-switch Blackboard, pull depository, banks, bases, caches, buffers, queues, stacks, storage, memory, blackboards, and clearinghouses.

5. A system according to claim 3, wherein the manipulation software application performs at least one of the functions from the group consisting of filtering, sorting, ranking, tagging, repackaging, consolidation, re-clustering, encapsulation, segmentation, decomposition, mutation, modification, personalization, and customization.

6. A system according to claim 1, wherein a plurality of consumer devices receive metadata from the intermediary adaptor; and use the metadata in purchasing decisions, choices and transactions.

7. A system according to claim 1, wherein metadata is at least one from the group consisting of coupons, advertisements, coupon-ad hybrids, discounts, rebates, rewards, incentives, gift cards, points, tokens, deals, promotions, samples, updates, alerts, announcements, notices, notes, labels, special offers, inducements, options, totems, logos, brands, brand names, icons, symbols, value cards, money cards, debit cards, savings, privileges, access, rights, authorizations, licenses, tickets, tags, promises, credits, permission, and validations.

8. A system according to claim 1, wherein an intermediary adaptor:
matches metadata from the metadata producers to the transaction-in progress-signal, sent by the financial software application; and
transmits metadata to the consumer device.

9. A system according to claim 1, wherein a delivery mechanism is at least one from the group consisting of a voice network, wireless network, Internet, local area network, wide area network, a metropolitan area network. Short code, keyword value pairs, bar code, portable bar code, mobile bar code, RFID tag formats (EPC), fax, fax mail, phone calls, voice calls, e-mail, wireless access protocol, instant messaging, mobile websites, pages and documents, text messaging, SMS, and multimedia messaging.

10. A system according to claim 4, wherein:
the push depository receives metadata, re-processes the metadata using software applications, and stores copies of the reprocessed metadata in the Inter-switch Blackboard;
the Inter-switch-Blackboard places the reprocessed metadata into the pull depository;
the pull depository implements algorithms to transmit the reprocessed metadata to one or more consumer devices.

11. A system according to claim 10, wherein the reprocessing software applications are at least one from the group software applications that filter, specialize, re-package, re-bundle, encapsulate, reformat, format convert, classify, abstract data type, vector code, tag, and structure metadata.

12. A system according to claim 10, wherein the algorithms implemented by the pull depository are Hidden Markov Models, or Artificial Neural Networks.

13. A system according to claim 1, further comprising a processor that barters metadata between a plurality of consumer devices.

14. A system according to claim 1, wherein the intermediary adapter matches metadata from metadata producers to metadata consumer devices by analyzing and matching producer and consumer preferences according to a Trickle Push algorithm.

15. A method for integrating pull and push flow of goods and services metadata, the method comprising:
producing metadata by metadata producers;
receiving metadata by a push depository of an intermediary adapter; and
reprocessing metadata by a push depository of an intermediary adapter; and
storing copies of the reprocessed data from the push depository to a pull depository of the intermediary adapter by an Inter-switch Blackboard of the intermediary adapter;
delivering metadata by the pull depository of the intermediary adapter through a plurality of delivery mechanisms.

16. The method according to claim 15, wherein the action of reprocessing metadata is at least one from the group consisting of filtering, specializing, re-packaging, re-bundling, encapsulating, reformatting, format converting, classifying, abstract data typing, vector coding, tagging, and structuring.

17. A method according to claim 15, wherein the algorithms to deliver metadata by the pull depository are implemented by Hidden Markov Models, or Artificial Neural Networks.

18. A method according to claim 15, further comprising:
transmitting to the intermediary adaptor a transaction in-progress signal using a financial software application;
matches metadata from the metadata producers to the transaction-in progress-signal, sent by the financial software application; and
transmits metadata to the consumer device.

19. A method according to claim 15, further comprising bartering metadata between a plurality of consumer devices.

20. A method according to claim 15, further comprising analyzing metadata producer and consumer preferences according to a Trickle Push access algorithm; and delivering metadata to consumer devices based on
